(19) United States
(12) Patent Application Publication
(10) Pub. No.: US 2024/0187963 A1
(43) Pub. Date: Jun. 6, 2024

(54) DYNAMIC USER PLANE MANAGEMENT

(71) Applicant: INTERDIGITAL PATENT HOLDINGS, INC., Wilmington, DE (US)

(72) Inventors: Zhuo CHEN, Claymont, DE (US); Pascal ADJAKPLE, Great Neck, NY (US); Kyle PAN, Saint James, NY (US); Rocco DI GIROLAMO, Laval (CA); Guodong ZHANG, Woodbury, NY (US); Yifan LI, Conshohocken, PA (US); Jerome VOGEDES, Milwaukee, WI (US)

(21) Appl. No.: 18/553,395

(22) PCT Filed: Mar. 31, 2022
(86) PCT No.: PCT/US2022/022896

§ 371 Date: Sep. 29, 2023

Related U.S. Application Data
(60) Provisional application No. 63/168,547, filed on Mar. 31, 2021.

(51) Int. Cl. H04W 40/22; H04W 40/24

(52) U.S. Cl. CPC H04W 40/22; H04W 40/246

(57) ABSTRACT

Methods for dynamic user plane management may include new Layer 2 architectures for supporting simultaneous User Plane direct and indirect connections between a remote UE and gNB. Methods are described for dynamically managing UP Plane connections based on the QoS requirement of the traffic flow and the power consumption requirement of the remote UE. A method is described for dynamically managing CP connections between a remote UE and remote UE via a direct CP connection. A method is described for dynamically managing CP connections between a remote UE and remote UE via an indirect CP connection.

### CROSS-REFERENCE TO RELATED APPLICATIONS

This application claims the benefit of U.S. Provisional Patent Application No. 63/168,547, filed on Mar. 31, 2021, entitled “Methods And Apparatus For Dynamic User Plane Management,” the contents of which are hereby incorporated by reference herein.

### BACKGROUND

As described in 3GPP TR 36.836 V2.0.0 Study on NR Sidelink Relay (Release 17), a first version of NR Sidelink has been developed that solely focuses on supporting V2X related road safety services in Release 16. The design aims to provide support for broadcast, groupcast and unicast communications in both out-of-coverage and in-network coverage scenarios.

### SUMMARY

Described herein are methods, apparatus, and systems for dynamic user plane management. In one aspect, new Layer 2 (L2) architectures are described for supporting simultaneous User Plane (UP) direct and indirect connections between a remote UE and gNB.

In another aspect, methods are described for dynamically managing User Plane connections based on the QoS requirement of the traffic flow and the power consumption requirement of the remote UE. In one example, a method is described for dynamically managing UP connections between a remote UE and a gNBE via a direct Control Plane (CP) connection. In another example, a method is described for dynamically managing UP connections between a remote UE and a gNB via an indirect CP connection.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. In the drawings:

FIG. 1 shows a User Plane protocol stack for L2 UE-to-Network Relay;

FIG. 2 shows a Control Plane protocol stack for L2 UE-to-Network Relay;

FIG. 3 shows another User Plane protocol stack for L2 UE-to-Network Relay;

FIG. 4 shows another Control Plane protocol stack for L2 UE-to-Network Relay;

FIG. 5 shows an example use case;

FIG. 6 shows an example of simultaneous User Plane connection via a direct and indirect path;

FIG. 7 shows an example of a Control Plane via direct path and a User Plane via indirect path;

FIG. 8 shows an example of a Control Plane via indirect path and a User Plane via direct path;

FIG. 9 shows an example of User Plane connectivity management when Control Plane is on a direct path;

FIG. 10 shows an example of User Plane Connectivity Management when Control Plane is on an indirect path;

FIG. 11 shows an example of multiple User Plane connections at PDCP layer via direct and indirect path;

FIG. 12 shows an example of multiple User Plane connections at RLC layer via direct and indirect path;

FIG. 13 shows an example method for dynamically managing UP connections between a gNB and remote UE via a direct CP connection;

FIG. 14 shows an example method for dynamically managing UP connections between a gNB and remote UE via an indirect CP connection;

FIG. 15A shows an example communications system;

FIG. 15B shows an example radio access networks (RANs) and core networks;

FIG. 15C shows an example radio access networks (RANs) and core networks;

FIG. 15D shows an example radio access networks (RANs) and core networks;

FIG. 15E shows another example communications system;

FIG. 15F shows an example communications apparatus or device; and

FIG. 15G shows an example computing system.

### DETAILED DESCRIPTION

As described in 3GPP TR 36.836 V2.0.0 Study on NR Sidelink Relay (Release 17), a first version of NR Sidelink has been developed that solely focuses on supporting V2X related road safety services in Release 16. The design aims to provide support for broadcast, groupcast and unicast communications in both out-of-coverage and in-network coverage scenarios.

To further explore coverage extension for Sidelink-based communications, the following may be considered: UE-to-network coverage extension or UE-to-UE coverage extension.

UE-to-network coverage extension: Uu coverage reachability is necessary for UEs to reach server in PDN network or counterpart UE out of proximity area. However, release-13 solution on UE-to-network relay is limited to EUTRA-based technology, and thus cannot be applied to NR-based system, for both NG-RAN and NR-based Sidelink communication.

UE-to-UE coverage extension: Currently proximity reachability is limited to single-hop for the Sidelink communication, either via EUTRA-based or NR-based Sidelink technology. However, that is not enough in the scenario where there is no Uu coverage and satellite coverage, considering the limited single-hop Sidelink coverage.

Overall, Sidelink connectivity may be further extended in NR framework, in order to support the enhanced QoS requirements.

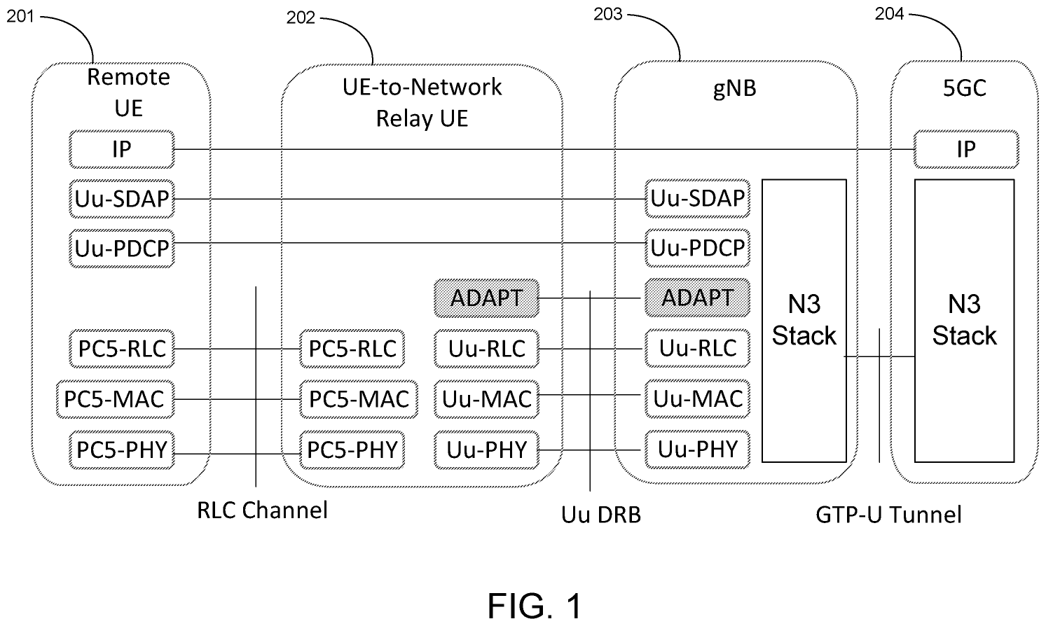

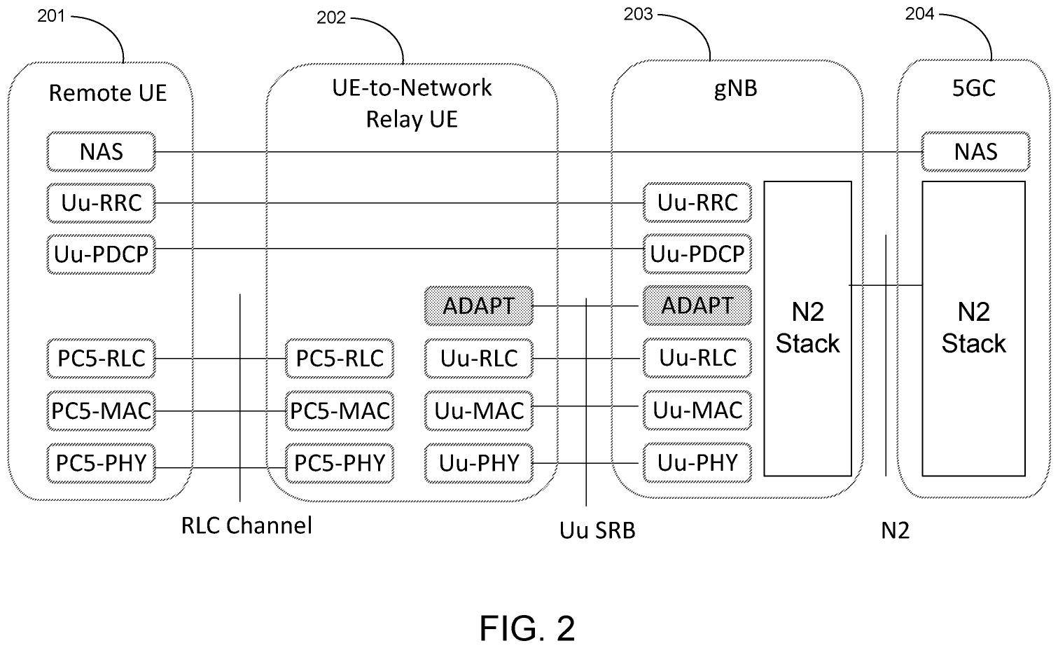

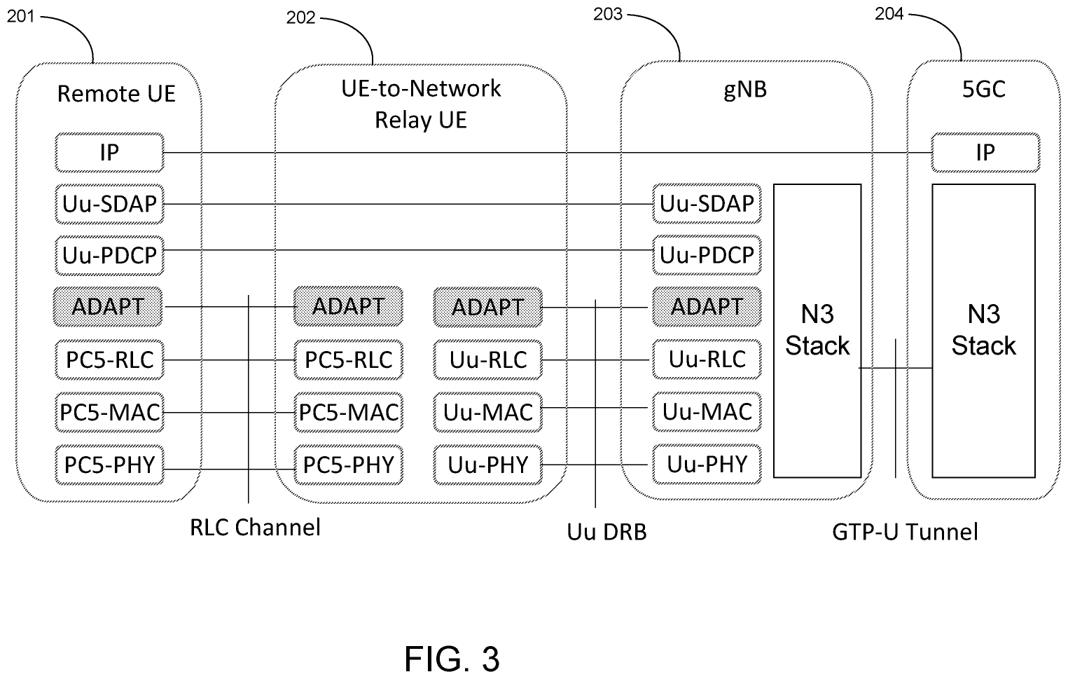

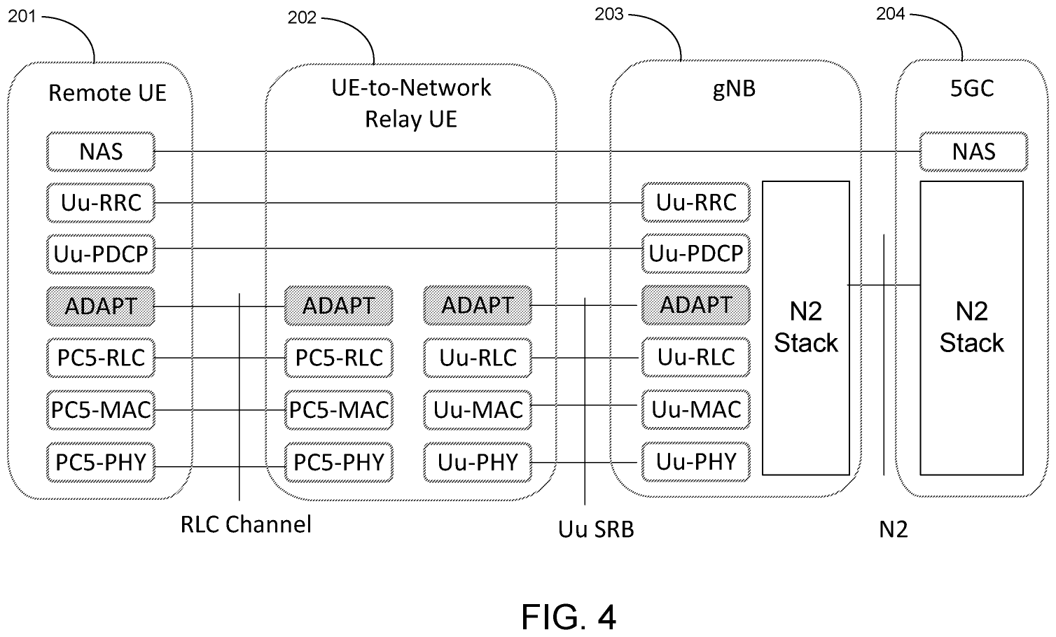

The protocol stacks for the User Plane and Control Plane of L2 UE-to-Network Relay architecture are described in FIG. 1 and FIG. 2 for the case where adaptation layer is not supported at the PC5 interface, and FIG. 3 and FIG. 4 for the case where adaptation layer is supported at the PC5 interface.

For L2 UE-to-Network Relay, the adaptation layer is placed over RLC sublayer for both control plane (CP) and user plane (UP) at the Uu interface between Relay UE 202 and gNB 203. The Uu SDAP/PDCP and RRC are terminated between Remote UE 201 and gNB 203, while RLC, MAC, and PHY are terminated in each link (e.g., the link between Remote UE 201 and UE-to-Network Relay UE 202 and the link between UE-to-Network Relay UE 202 and the gNB 203). Whether the adaptation layer is also supported at the PC5 interface between Remote UE 201 and Relay UE 202 is left to WI phase (assuming down-selection first before studying too much on the detailed PC5 adaptation layer functionalities).

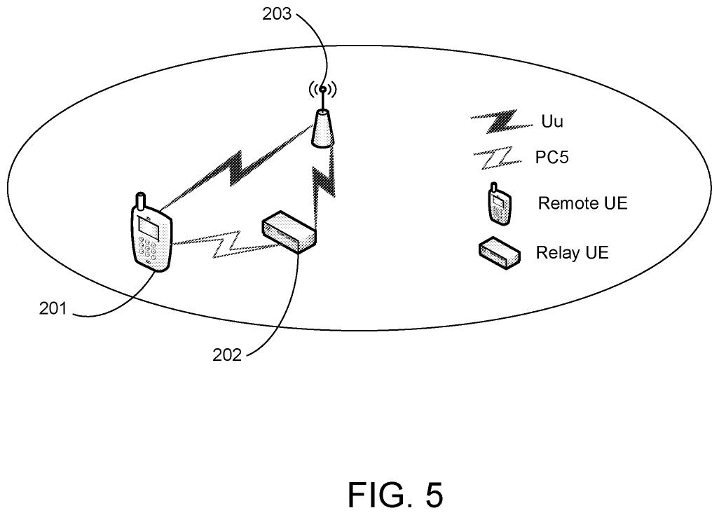

FIG. 5 shows an example use case in which a remote UE 201 is in coverage of the same cell as a Relay UE 202.

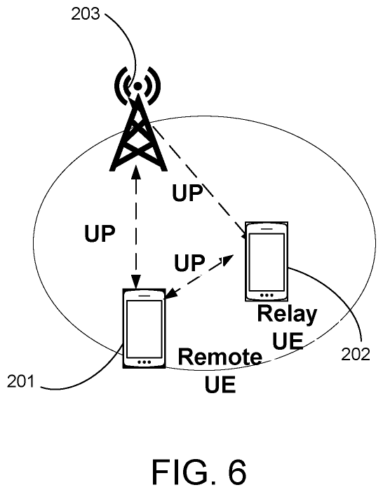

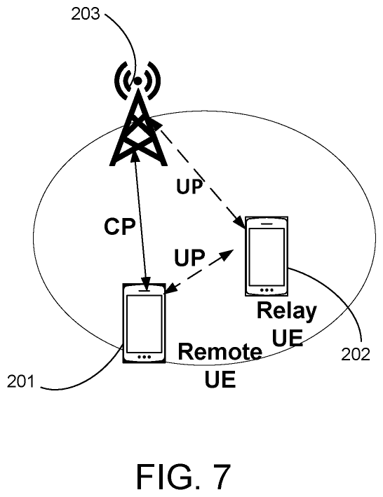

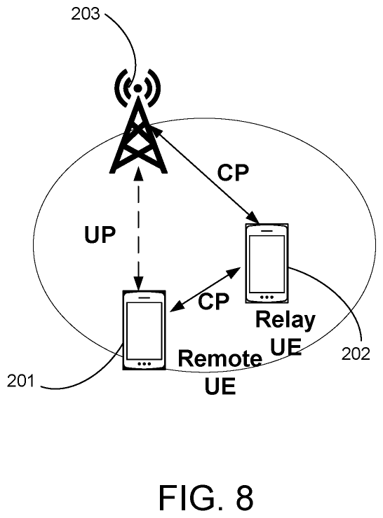

Release 17 sidelink relay design decisions may support the remote UE 201 which may have a direct Uu connection or a connection via a single relay UE 202, but these two connections should not be active at the same time. In other words, this design decision limits (for example, preventing) the remote UE 201 to have User Plane via direct and indirect path simultaneously as shown in FIG. 6. Having simultaneous connections via direct and indirect path can provide reliable communications for the remote UE 201. Moreover, Release 17 Sidelink relay design also limits the Control Plane connection and the User Plane connection to use the same path. Having a Control Plane connection and a User Plane connection via different paths can reduce the power consumption of remote UE 201, as this allows for example, the possibility to route the user plane traffic through a relay node in close proximity for shorter-range transmission thereby saving power, while keeping the control plane traffic over the direct path. Such user plane and control plane split also provides the flexibility for latency reduction as the user plane traffic with usually higher data rate can be routed through a relay node in close-proximity taking advantage of shorter-range transmission and better radio conditions thereby eliminating potential retransmission and hence reducing overall latency for data packets, while keeping the control plane traffic with typically lower data rate on the direct path. For example, in the scenario that the remote UE 201 has Control Plane connection via the direct path, and the User Plane connection via the indirect path as shown in FIG. 7, the remote UE 201 can reduce the power consumption since it is closer to the relay UE 202 than to the gNB 203. In another example in the scenario that the remote UE 201 has a Control Plane connection via the indirect path, and the User Plane connection via the direct path as shown in FIG. 8, the remote UE 201 can reduce the transmission latency potentially for the user plane traffic since it is one hop away from the gNB 203, while using the indirect path for the control traffic with low data rate over an indirect path.

One consideration is that the current 5G architecture does not support simultaneous User Plane connection via direct and indirect path. Disclosed herein is an architecture that supports a remote UE 201 to have at least a direct User Plane connection or an indirect User Plane connection. The remote UE 201 may use the direct connection and the indirect connection to transmit identical traffic to increase the reliability of the communication. The remote UE 201 can also use the direct connection or the indirect connection to transmit different traffic to meet the QoS or power consumption requirements.

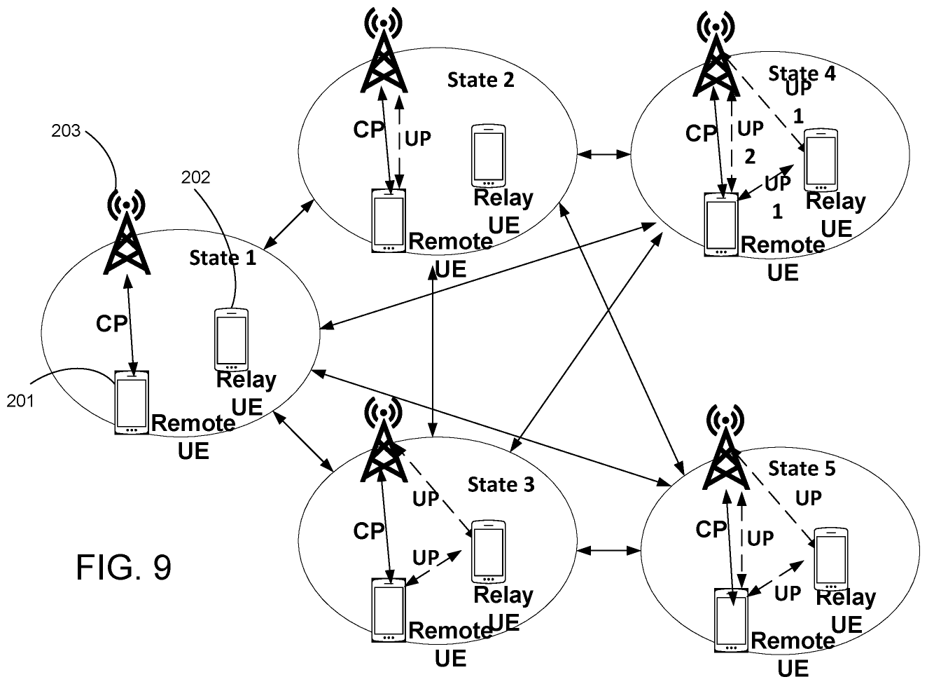

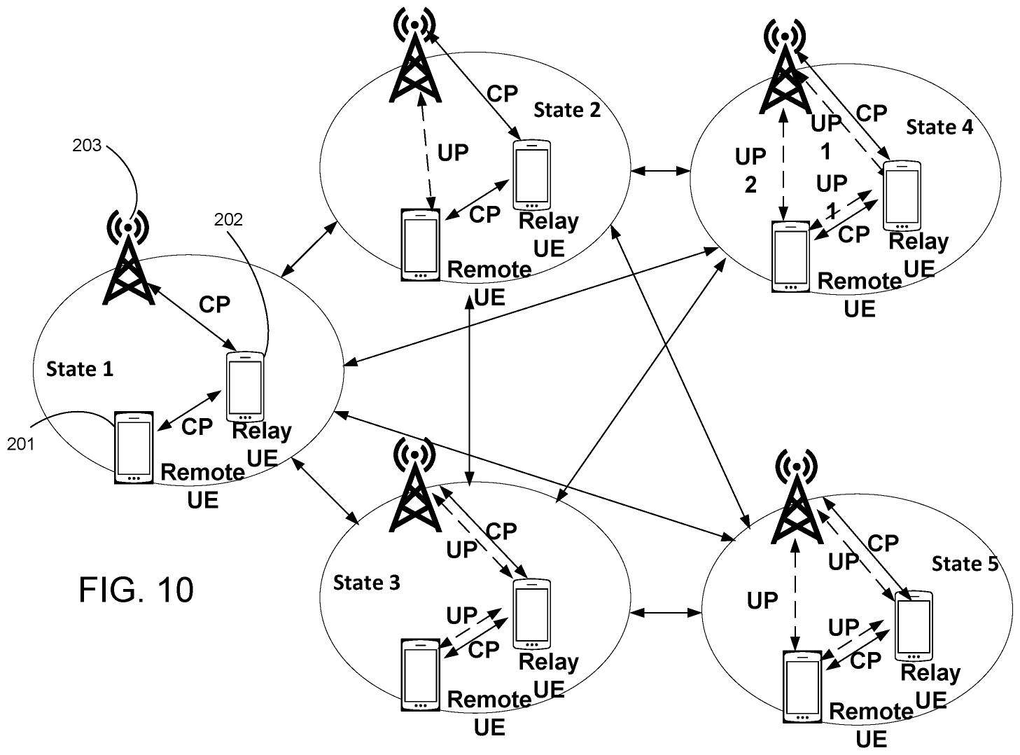

Another consideration is that new User Plane management procedures are needed to support simultaneous User Plane connections. In the scenario that Control Plane is on the direct path as shown in FIG. 9, the remote UE 201 needs to dynamically manage its User Plane connections on a direct path or indirect paths. In the scenario that the Control Plane is on the indirect path as shown in FIG. 10, the remote UE needs to dynamically manage its User Plane connections on a direct path or indirect paths. For example, what are the triggering events of User Plane management procedure. How to select a User Plane path to meet the QoS requirements of the traffic flow and the capability requirements of the remote UE 201? How to configure the remote UE 201 and relay UE 202 via a direct path or indirect path to meet the QoS requirements of the traffic flow?

With these considerations in mind, described herein are methods, apparatus, or systems for dynamic user plane management.

In one aspect, Layer 2 architectures are described herein for supporting simultaneous User Plane direct and indirect connections between a remote UE 201 and gNB 203.

In another aspect, methods are described for dynamically managing UP Plane connections based on the QoS requirement of the traffic flow and the power consumption requirement of the remote UE 201. In one example, a method is described for dynamically managing UP connections between a remote UE 201 and a gNB 203 via a direct CP connection. In another example, a method is described for dynamically managing UP connections between a remote UE 201 and a gNB 203 via an indirect CP connection.

In the following, the term UP connection may be understood as a connection between remote UE 201 and the gNB 203 that carries user plane information and may be made up of one or more data radio bearers (DRBs) between the remote UE 201 and the gNB 203 (which may be communicatively connected between one or more hops). Hereinafter the terms UP connection and DRB connection are sometimes used interchangeably. Similarly in the following, the term CP connection may be understood as a connection between remote UE 201 and the gNB 203 that carries control plane information and may be made up of one or more signaling radio bearers (SRBs) between the remote UE 201 and the gNB 203 (which may be communicatively connected between one or more hops). Hereinafter the terms CP connection and SRB connection are sometimes used interchangeably. Also, although a gNB 203 is referred to herein, any base station may be applicable.

In the following, the term direct connection may be understood as a connection that uses a direct path. For example, communication between the gNB 203 and the remote UE 201 is over the Uu interface. Similarly, the term indirect connection may be understood as a connection that uses an indirect path. For example, communication between the gNB 203 and the remote UE 201 is via a relay UE 202.

### Architecture to Support Dynamic User Plane Connections

Hereinafter, the term connection is also applied to the various protocol layers of the UE Access Stratum. For example, with reference to an SDAP connection, or PDCP connection. This terminology is used mainly to describe the endpoints or termination points of these protocols. So an SDAP connection between the remote UE 201 and the gNB 203 implies that the remote UE and the gNB 203 are the termination points of the SDAP protocol.

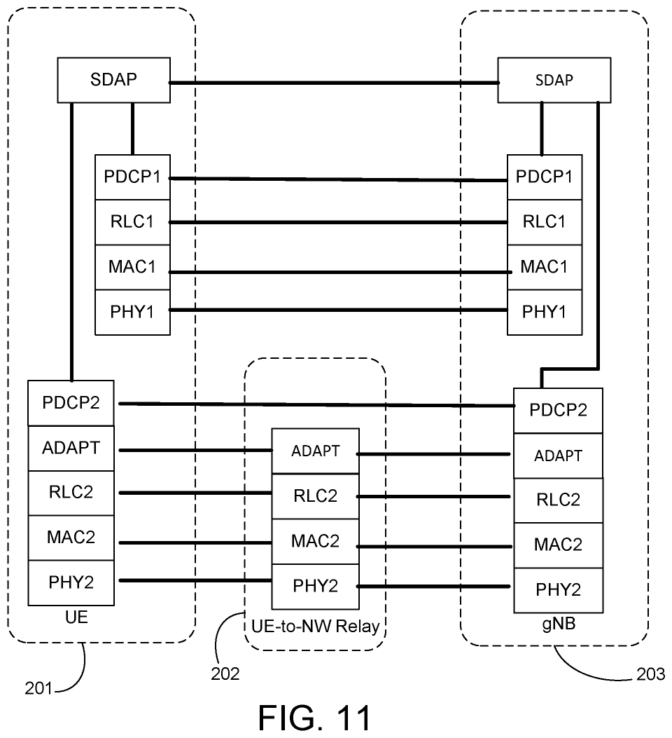

Multiple architectures are described for supporting dynamic User Plane connections. In a first disclosed architecture as shown in FIG. 11, the remote UE 201 and the gNB 203 have one common SDAP layer connection; but also have a direct end-to-end connection at PDCP layer, RLC, MAC, or PHY layer, and in indirect end-to-end connection at PDCP layer, an indirect hop-by-hop connection at Adaptation, RLC, MAC, or PHY layer. In one example, SDAP is Uu-SDAP; the PDCP1 is Uu-PDCP; RLC1 is Uu-RLC; MAC1 is Uu-MAC; PHY1 is Uu-PHY. PDCP2 is Uu-PDCP; RLC2 is PC5-RLC; MAC2 is PC5-MAC; or PHY2 is PC5-PHY.

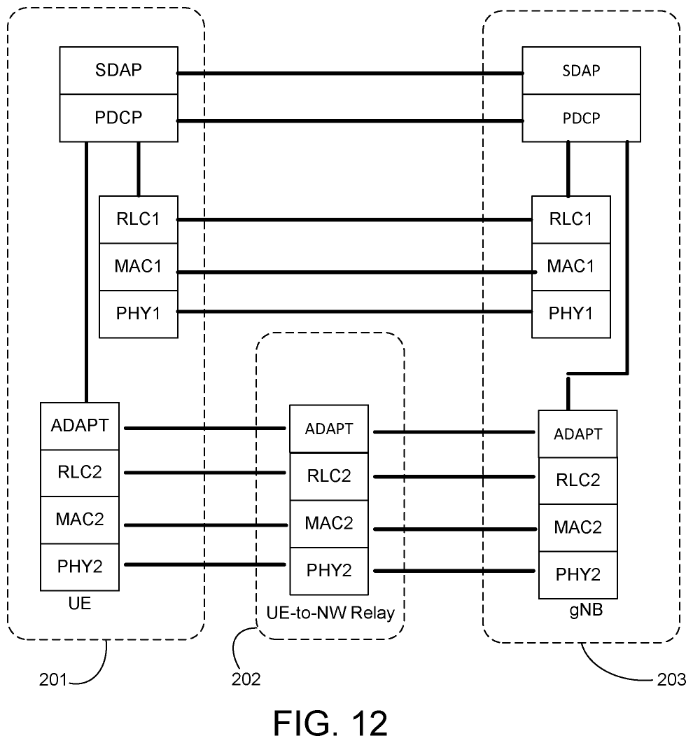

In a second disclosed architecture as shown in FIG. 12, the remote UE 201 and the gNB 203 have one common SDAP and PDCP layer connection; but also have a direct end-to-end connection at RLC, MAC, or PHY layer, and an indirect hop by hop connection at Adaptation, RLC, MAC, or PHY layer. In this example, the RLC1 is Uu-RLC; MAC1 is Uu-MAC; PHY1 is Uu-PHY. RLC2 is PC5-RLC; MAC2 is PC5-MAC; or PHY2 is PC5-PHY.

### User Plane Management

New User Plane management methods are described herein to support dynamic User Plane connections.

### Dynamic UP Connection Management Via a Direct Path

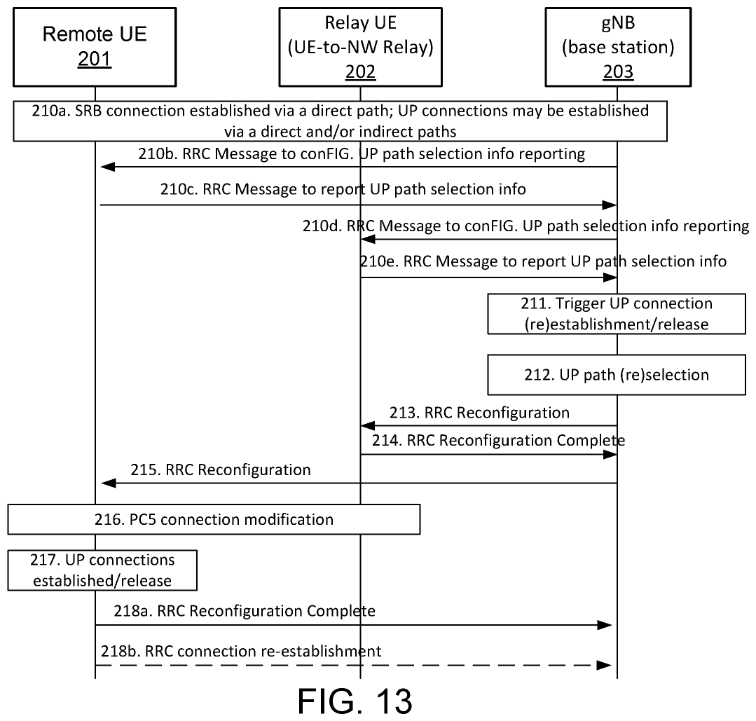

In the scenario where Control Plane is on the direct path as shown in FIG. 9, the gNB 203 may dynamically manage its User Plane connection between the remote UE 201, as shown in FIG. 13.

With reference to FIG. 13, a remote UE 201 and a gNB 203 may perform the following steps for (re)establishing or release UP connections.

In step 210a, the remote UE 201 may establish SRB connections with the gNB 203 via a direct path, and the remote UE 201 may also have established UP connection with the gNB 203 via a direct path or indirect paths.

In step 210b, the gNB 203 may send an RRC message to the remote UE 201 to configure the remote UE 201 measuring and reporting UP path selection context information via a direct path. The gNB 203 may configure the remote UE 201 to report the information periodically or when the context information change exceeds a configured threshold.

In step 210c, the remote UE 201 may send an RRC message to the gNB 203 to report UP path selection context information via a direct path. Hereinafter, this context information may also be referred to as path selection context information. The UP path selection context information may include the information of the list of candidate relay UEs. This may be a list of UEs which are suitable to act as Relay UEs)(for example list of UE IDs for UEs that meet threshold metric or the like to act as Relay UEs), the preference of the relay UE 202 (e.g., the relay UE 202 that has the highest capacity), the relay UE 202 that has the best signal quality, the battery status of the remote UE 201, the battery status of the relay UE 202, power saving requirements of the remote UE 201, or power savings requirements of the relay UE 202, among other things.

In step 210d, the gNB 203 may send an RRC message to the relay UE 202 to configure the relay UE 202 for measuring and reporting UP path selection context information.

In step 210e, the relay UE 202 may send an RRC message to the gNB 203 to report UP path selection context information. The UP path selection context information may include its traffic load (e.g. Channel Busy Ratio), its battery status, number of remote UE 201s using the UE as a relay UE 202, or the like.

In step 211, the gNB 203 is triggered to (re)establish or release UP connections with the remote UE 201. The UP connections (re)establishment or release may be triggered when it receives a PDU SESSION RESOURCE MODIFY REQUEST message (or another message), which may be from AMF for a new QoS flow or a PDU SESSION RESOURCE SETUP REQUEST message from AMF. The UP connections establishment may be triggered when gNB 203 receives a new traffic flow from a remote UE 201 and existing connections cannot fulfill the QoS requirement of the traffic flow (e.g., a QoS threshold). The UP connections re-establishment may be triggered when the existing UP connections are broken or cannot fulfill the QoS requirement.

In step 212, based on the QoS requirement, the gNB 203 may select the paths to (re)establish or release UP connections. In one example, if using the indirect path meets latency requirements of the flow and the remote UE 201 requests to minimize the power consumption, the gNB 203 may select a relay UE 202 to establish UP connection on an indirect path. The remote UE 201 may indicate to the gNB 203, the metric to use to make the relay UE 201 selection. In one example, the metric may be the available capacity at the relay UE 202. The gNB 203 may select the relay UE 202 with the largest available capacity. In another example the metric may be the channel load between the remote UE 201 and relay UE 202 or the channel load between the relay UE 202 and gNB 203. The load may be the Channel Busy Ratio. The gNB 203 may select the relay UE 202 with lowest channel load. In another example, if using the indirect path cannot meet the latency requirements of the flow, the gNB 203 may select the direct path to establish a UP connection. In yet another example, if using neither direct path nor indirect path cannot meet the reliability requirements of the flow, the gNB 203 may select both direct path and indirect path and transmit duplicated packet on both paths to meet the reliability requirements. In the scenario that the remote UE 201 has UP connections on both a direct path and an indirect path, if using the indirect path can meet latency requirements of the flow and the remote UE 201 requests to minimize the power consumption, the gNB 203 may release the direct path. In another example, if using the indirect path cannot meet the latency requirements of the flow, the gNB 203 may release the UP connection on the indirect path.

In step 213, to establish or release a UP connection via an indirect path, the gNB 203 may send user plane connection configuration information to the selected relay UE 202. The sending may be via an RRC reconfiguration message to the selected relay UE 202. For establishment of a UP connection, the RRC reconfiguration message may include bearer ID, the remote UE ID and RLC channel mapping configuration associated with the new connection. The RRC reconfiguration message may also include the QoS requirement of the traffic flow. For release of a UP connection, the RRC reconfiguration message may include bearer ID, the remote UE ID, or RLC channel mapping configuration associated with the connection to be released. The user plane connection configuration information may include a bearer identifier (ID), UE ID of a device (e.g., a remote UE or relay UE), Radio Link Control (RLC) channel mapping configuration associated with a new sidelink connection, or Quality of Service (QoS) requirement of the traffic flow, among other things.

In step 214, the relay UE 202 may configure its adaptation layer based on the RRC reconfiguration message. The relay UE 202 may send an RRC reconfiguration complete message to the gNB 203 to confirm the configuration for the UP connections.

In step 215, the gNB 203 may send user plane connection configuration information to the remote UE 201. This may be via an RRC reconfiguration message to the remote UE 201 via the Uu interface. To establish a UP connection via indirect path, the RRC reconfiguration message may include an indirect path configuration indication, bearer ID (for example a DRB ID), the selected relay UE ID and RLC channel mapping configuration associated with the new connection. The RRC reconfiguration message may also include the QoS requirement of the traffic flow for the remote UE 201 to establish a PC5 connection with the selected relay UE 202. To establish a UP connection via direct path, the RRC reconfiguration message may include the legacy Uu UP configuration.

In step 216, based on the information received from the RRC reconfiguration message of step 215, the remote UE 201 or the relay UE 202 may establish a sidelink UP or release a sidelink UP if the existing Sidelink UP cannot meet the QoS requirement of the new traffic flow.

In step 217, after the new UP connection is established, the remote UE 201 may map the data flow packet to one or more PDCP entities, one can be Uu-PDCP or PC5 PDCP. The remote UE 201 may also map the data flow packet to the same PDCP entities, but one or more RLC entities, one can be Uu-RLC or PC5 RLC.

In step 218a, if the Sidelink UP is established or released successfully, the remote UE 201 sends a RRC reconfiguration complete message to the gNB 203 to confirm the configuration for the UP. After the new UP connection is established, the gNB 203 may map the data flow packet to one or more PDCP entities, one can be Uu-PDCP or PC5 PDCP. The gNB 203 may also map the data flow packet to the same PDCP entities, but one or more RLC entities, one can be Uu-RLC or PC5 RLC.

In step 218b, if the Sidelink UP is established or released unsuccessfully, the remote UE 201 sends an RRC reconfiguration re-establishment message to the gNB 203 for notification of the failure. The gNB 203 may need to do UP path reselection as in step 212.

If at step 212 the gNB 203 determines to set up the UP connection over a direct path, rather than over an indirect path, then the gNB 203 may send an RRC reconfiguration message to the remote UE 201 using the direct CP connection. The RRC reconfiguration message may include the legacy Uu UP configuration. After configuration, the remote UE 201 may send an RRC reconfiguration complete message to the gNB 203.

If at step 212 the gNB 203 determines to set up both a UP connection over a direct path and over an indirect path, then the gNB 203 may send an RRC reconfiguration message to the relay UE 202 (as in Step 213), as well as an RRC reconfiguration message to the remote UE 201 (as in step 215). However, the latter message may include configuration information for both the direct path and the indirect path.

Note that FIG. 13 shows the steps to establish, re-establish, or release UP connections. This may be based on the inputs from the core network or on the arrival of a new flow to the gNB 203. In addition to these inputs, triggers may occur at the gNB 203 to modify a UP connection. For example, to change a UP connection from a direct path to an indirect path, from an indirect path to a direct path, from transmission over a single path to transmission over both paths for throughput, from transmission over a single path to transmission over both paths for reliability, or from transmission over both paths to transmission over a single path.

A first such trigger may be based on measurement reports from the remote UE 201 or the relay UE 202. The measurement report may include an indication of the signal quality crossing over a threshold. This threshold may be different from the threshold used for mobility considerations. The measurement report may include an indication of the signal load crossing over a threshold. The measurement report may include an indication of the battery status crossing over a threshold. As can be inferred, the triggers may be events that may happen at a base station that informs the base station to modify a UP connection.

A second such trigger may be a physical layer indication from the remote UE 201 or the relay UE 202. A third such trigger may be a MAC control element from the remote UE 201 or the relay UE. A fourth such trigger may be an RRC message from the remote UE 201 or the relay UE 202.

A fifth such trigger may be a NAS message from the remote UE 201 or the relay UE 202. The NAS message may include an indication regarding the latency of the flow. For example, whether a threshold latency of the flow is being met or not met. As another alternative, the NAS message may include an indication regarding the throughput of the flow. For example, whether a threshold throughput requirement is being met or not met.

Note that FIG. 13 shows the UP connection may be established via an RRC Reconfiguration procedure. As an alternative, the UP connection may also be established via an RRC connection establishment procedure. In such a case, the configuration of the UP connection may be included in a gNB 203 RRC Setup message. The remote UE 201 response may be included in an RRC Setup Complete message (e.g., for successful establishment) or in an RRC Reject message (for unsuccessful establishment). The relay UE 202 response may be included in an RRC Setup Complete message (e.g., for successful establishment) in an RRC Reject message (e.g., for unsuccessful establishment).

### Dynamic UP Connection Management Via an Indirect Path

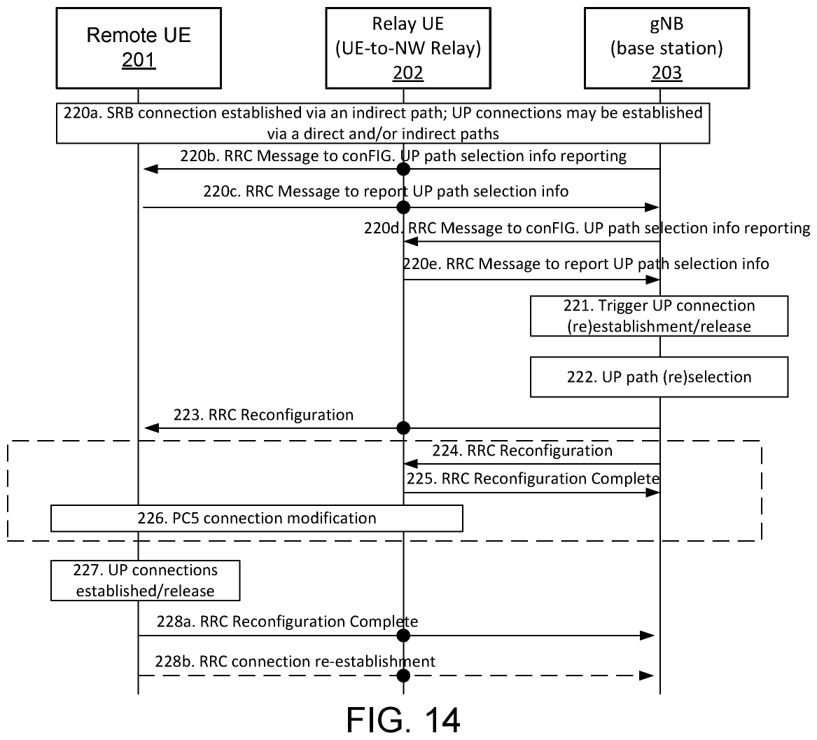

In the scenario that the Control Plane (CP) is on the indirect path as shown in FIG. 10, the gNB 203 may dynamically manages its User Plane (UP) connection between the remote UE 201 as shown in FIG. 14.

With reference to FIG. 14, a remote UE 201 and a gNB 203 may perform the following steps for (re)establishing or releasing UP connections.

In step 220a, the remote UE 201 may establish SRB connection(s) with the gNB 203 via an indirect path. The remote UE 201 may also have established UP connection with the gNB 203 via a direct path or indirect paths.

In step 220b, the gNB 203 may send an RRC message to the remote UE 201 to configure the remote UE 201 for measuring and reporting UP path selection context information via an indirect path. The gNB 203 may configure the remote UE 201 to report the information periodically or when the context information change exceeds a configured threshold.

In step 220c, the remote UE 201 may send an RRC message to the gNB 203 to report UP path selection context information via an indirect path. The UP path selection context information may include the information of the candidate relay UE, the preference of the relay UE 202 (e.g., the relay UE 202 that has the highest capacity), the relay UE that has the best signal quality, the battery status of the remote UE 201, the battery status of the relay UE 202, power saving requirements of the remote UE 201, or power savings requirements of the relay UE 202, among other things.

In step 220d, the gNB 203 may send an RRC message to the relay UE 202 to configure the relay UE 202 for measuring and reporting UP path selection context information.

In step 220e, the relay UE 202 may send an RRC message to the gNB 203 to report UP path selection context information. The UP path selection context information may include its traffic load (e.g., Channel Busy Ratio), its battery status, number of remote UEs using the UE as a relay UE 202, or the like.

In step 221, the gNB 203 is triggered to (re)establish or release UP connections with the remote UE 201. The UP connections (re)establishment or release may be triggered when it receives a PDU SESSION RESOURCE MODIFY REQUEST message (or another message), which may be from AMF for a new QoS flow or a PDU SESSION RESOURCE SETUP REQUEST message from AMF. The UP connections establishment may be triggered when the gNB 203 receives a new traffic flow from a remote UE 201 and existing connections cannot fulfill the QoS requirement of the traffic flow (e.g., a QoS threshold). The UP connections re-establishment may be triggered when the exiting UP connections are broken or cannot fulfill the QoS requirement.

In step 222, based on the QoS requirement, the gNB 203 may select the paths to (re)establish or release UP connections. In one example, if using the indirect path meets latency requirements of the flow and the remote UE 201 requests to minimize the power consumption, the gNB 203 may select a relay UE 202 to establish UP connection on an indirect path. The remote UE 201 may indicate to the gNB 203, the metric to use to make the relay UE 201 selection. In one example, the metric may be the available capacity at the relay UE 202. The gNB 203 may select the relay UE 202 with the largest available capacity. In another example the metric may be the channel load between the remote UE 201 and relay UE 202 or the channel load between the relay UE 202 and gNB 203. The load may be the Channel Busy Ratio. The gNB 203 may select the relay UE 202 with lowest channel load. In another example, if using the indirect path cannot meet the latency requirements of the flow, the gNB 203 may select the direct path to establish a UP connection. In yet another example, if using neither direct path nor indirect path cannot meet the reliability requirements of the flow, the gNB 203 may select both direct path and indirect path and transmit duplicated packet on both paths to meet the reliability requirements. In the scenario that the remote UE 201 has UP connections on both a direct path and an indirect path. if using the indirect path can meet latency requirements of the flow and the remote UE 201 requests to minimize the power consumption, the gNB 203 may release the direct path. In another example, if using the indirect path cannot meet the latency requirements of the flow, the gNB 203 may release the UP connection on the indirect path.

In step 223, the gNB 203 may send user plane connection configuration information to the remote UE 201. This may be via an RRC reconfiguration message to the remote UE 201 via the relay UE 202. To establish a UP connection via indirect path, the RRC reconfiguration message may include an indirect path configuration indication, bearer ID, the selected relay UE ID and RLC channel mapping configuration associated with the new connection. The RRC reconfiguration message may also include the QoS requirement of the traffic flow for the remote UE 201 to establish a PC5 connection with the selected relay UE 202. To establish a UP connection via direct path, the RRC reconfiguration message may include the legacy Uu UP configuration.

In step 224, to establish or release a UP connection via an indirect path, the gNB 203 may send user plane connection configuration information to the selected relay UE 202. This may be via an RRC reconfiguration message to the selected relay UE 202. For establishment of a UP connection, the RRC reconfiguration message may includes bearer ID, the remote UE 201 ID and RLC channel mapping configuration associated with the new connection. The RRC reconfiguration message may also include the QoS requirement of the traffic flow. For release of a UP connection, the RRC reconfiguration message may include bearer ID (for example a DRB ID), the remote UE ID, or RLC channel mapping configuration associated with the connection to be released.

In step 225, the relay UE 202 may configure its adaptation layer based on the RRC reconfiguration message. The relay UE 202 may send an RRC reconfiguration complete message to the gNB 203 to confirm the configuration for the UP connections.

In step 226, based on the information received from the RRC reconfiguration message of step 225, the remote UE 201 or the relay UE 202 may modify or release an existing sidelink UP if it cannot meet the QoS requirement of the new traffic flow.

In step 227, after the new UP connection is established, the remote UE 201 may map the data flow packet to one or more PDCP entities, one can be Uu-PDCP or PC5 PDCP. The remote UE 201 may also map the data flow packet to the same PDCP entities, but one or more RLC entities, one can be Uu-RLC or PC5 RLC.

In step 228a, if the Sidelink UP is established or released successfully, the remote UE 201 sends an RRC reconfiguration complete message to the gNB 203 to confirm the configuration for the UP via the relay UE 202. After the new UP connection established, the gNB 203 may map the data flow packet to one or more PDCP entities, one can be Uu-PDCP or PC5 PDCP. The gNB 203 may also map the data flow packet to the same PDCP entities, but one or more RLC entities, one can be Uu-RLC or PC5 RLC.

In step 228b, if the Sidelink UP is established or released unsuccessfully, the remote UE 201 sends an RRC reconfiguration re-establishment message to the gNB 203 for notification of the failure. The gNB 203 needs to do UP path reselection as in step 222.

If at step 222 the gNB 203 determines to set up the UP connection over a direct path, rather than over an indirect path, then the gNB 203 may send an RRC reconfiguration message to the remote UE 201 using the indirect CP connection. The RRC reconfiguration message may include the legacy Uu UP configuration. After configuration the remote UE 201 may send an RRC reconfiguration complete message to the gNB 203.

If at step 222 the gNB 203 determines to set up both a UP connection over a direct path and over an indirect path, then the gNB 203 may send an RRC reconfiguration message to the relay UE 202 (as in step 224), as well as an RRC reconfiguration message to the remote UE 201 (as in Step 223). However, the latter message may include configuration information for both the direct path and the indirect path.

As an alternative to step 223 and step 224, a gNB 203 may transmit a single RRC reconfiguration message. This message may include the configuration for both the relay UE 202, as well as the remote UE 201. The configuration of the remote UE 201 may be included in a container of the single RRC reconfiguration message. The relay UE 202 may forward the configuration information to the remote UE 201 using PC5 RRC signaling,

Note that FIG. 14 shows the steps to establish, re-establish, or release UP connections. This is based on the inputs from the core network, or on the arrival of a new flow to the gNB 203. In addition to these inputs, triggers may occur at the gNB 203, to modify a UP connection. For example, to change a UP connection from a direct path to an indirect path, from an indirect path to a direct path, from transmission over a single path to transmission over both paths for throughput, from transmission over a single path to transmission over both paths for reliability, or from transmission over both paths to transmission over a single path.

A first such trigger may be based on measurement reports from the remote UE 201 or the relay UE 202. The measurement report may include an indication of the signal quality crossing over a threshold. This threshold may be different from the threshold used for mobility considerations. The measurement report may include an indication of the signal load crossing over a threshold. The measurement report may include an indication of the battery status crossing over a threshold.

A second such trigger may be a physical layer indication from the remote UE 201 or the relay UE 202. A third such trigger may be a MAC control element from the remote UE 201 or the relay UE 202. A fourth such trigger may be an RRC message from the remote UE 201 or the relay UE 202.

A fifth such trigger may be a NAS message from the remote UE 201 or the relay UE 202. The NAS message may include an indication regarding the latency of the flow. For example. whether a threshold latency of the flow is being met or not met. As another alternative, the NAS message may include an indication regarding the throughput of the flow. For example, whether a threshold throughput requirement is being met or not met.

Note that FIG. 14 shows the UP connection may be established via an RRC Reconfiguration procedure. As an alternative, the UP connection may also be established via an RRC connection establishment procedure. In such a case, the configuration of the UP connection may be included in a gNB 203 RRC Setup message. The remote UE 201 response may be included in an RRC Setup Complete message (e.g., for successful establishment) or in an RRC Reject message (e.g., for unsuccessful establishment). The relay UE 202 response may be included in an RRC Setup Complete message (e.g., for successful establishment) or in an RRC Reject message (e.g., for unsuccessful establishment).

The disclosed subject matter, which may be logic at the WTRU (e.g., UE), may allow WTRUs to become configured on a communication path1 with details on how to: 1) determine and send path selection information to gNB on path1, and 2) send UP traffic to gNB on path2. The control plane information and user plane information for the UE may be on different paths (one direct and one indirect).

The following Table 1 is a list of acronyms that may appear in the following description. Unless otherwise specified, the acronyms used herein refer to the corresponding terms listed below.

TABLE 1

| | |
|---|---|
| 3GPP | 3^{rd} Generation Partnership Project |
| ACK | ACKnowledgement |
| APP | APPlication |
| AS | Access Stratum |
| CP | Control Plane |
| DAG | Directed Acyclic Graph |
| D2D | Device to Device Communication |
| eNB | Evolved Node B |
| gNB | NR NodeB |
| ID | Identity or Identifier |
| ITS | Intelligent Transport System |
| ITS-AID | ITS Application Identifier |
| LCH | Logical Channel |
| LTE | Long Term Evolution |
| MAC | Medium Access Control |
| MO | Mobile Orientated |
| MT | Mobile Terminated |
| NAS | Non-AS |
| NB | NodeB |
| NR | New Radio |
| PC5 | The reference point between ProSe- |
| | enabled UEs used for control and User |
| | Plane for ProSe Direct Discovery, ProSe |
| | Direct Communication and ProSe UE- |
| | to-Network Relay |
| PCF | Policy Charging Function |
| PDCP | Packet Data Convergence Protocol |
| PDN | Packet Data Network |
| PDU | Protocol Data Unit |
| PHY | PHYsical layer |
| ProSe | Proximity-Based Services |
| PSID | Provider Service Identifier |
| QoS | Quality of Service |
| SDU | Service Data Unit |
| SL | Sidelink |
| RAN | Radio Access Network |
| RAP | Relay Adaptation Protocol |
| RLC | Radio Link Control |
| RLF | Radio Link Failure |
| RRC | Radio Resource Control |
| RSU | Roadside Unit |
| UE | User Equipment |
| UL | Uplink |
| ULG | Upper Layer Group |
| UP | User Plane |
| V2X | Vehicle-to-X Communication |

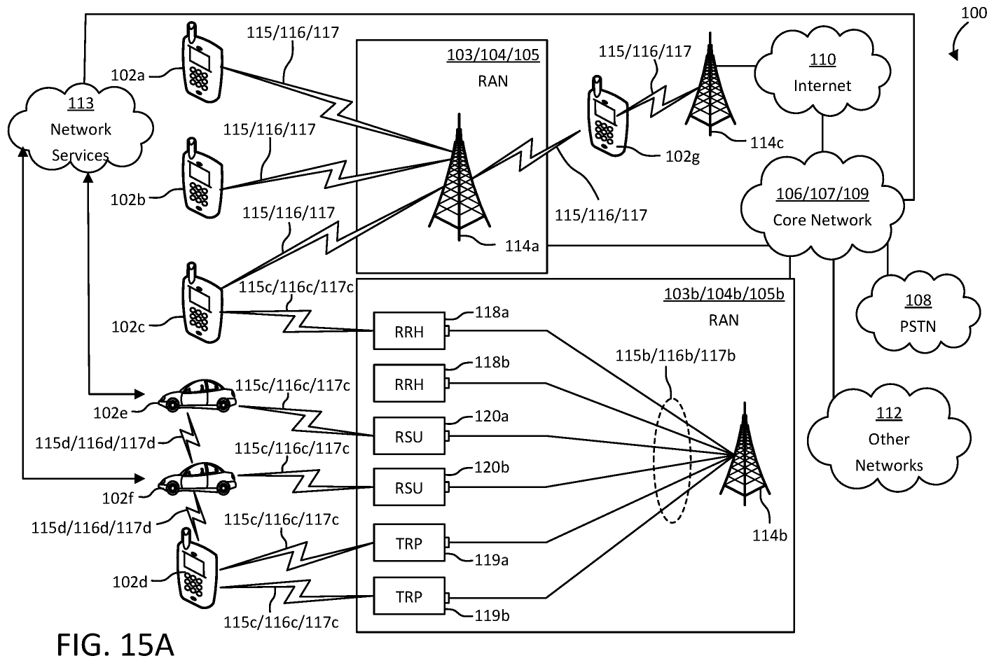

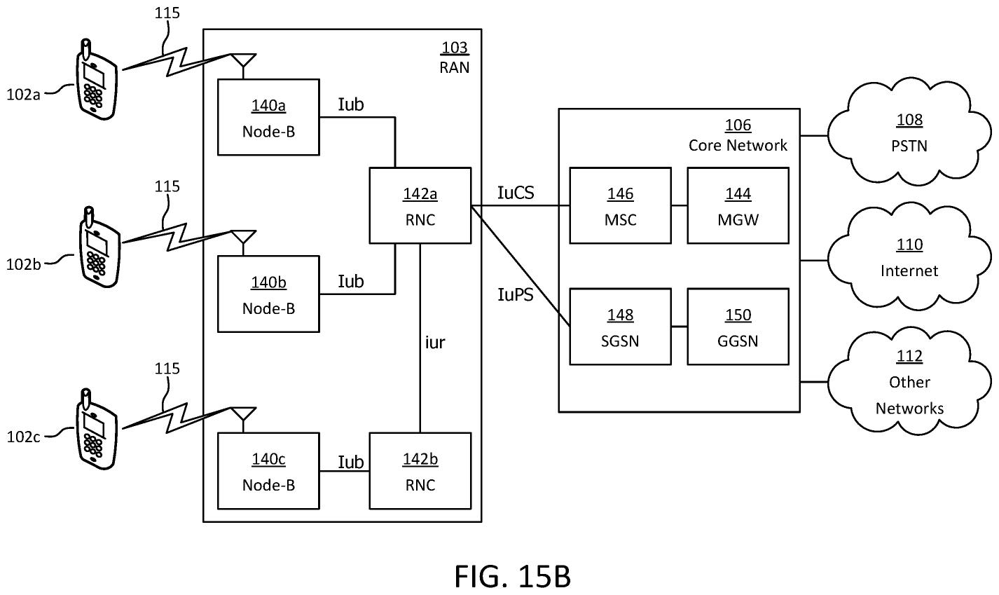

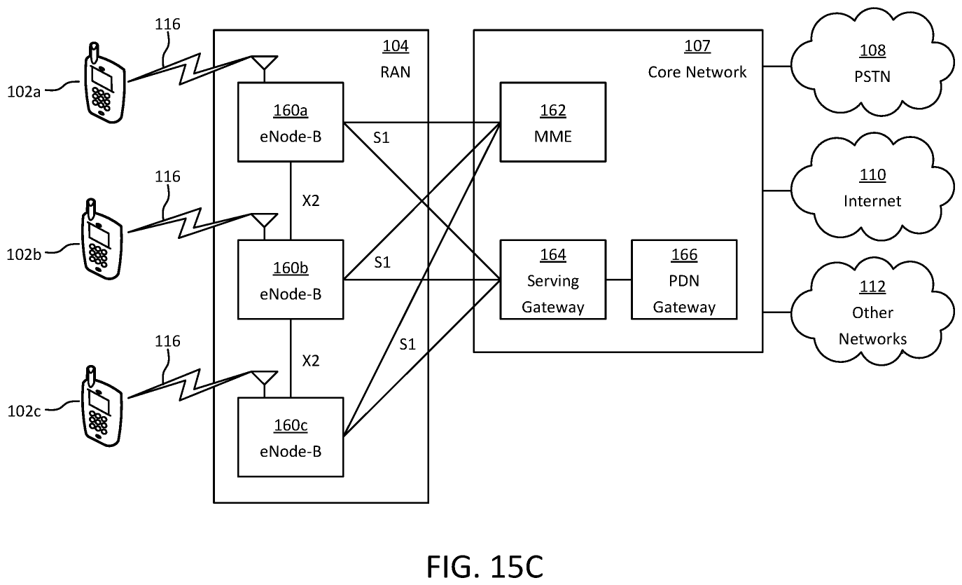

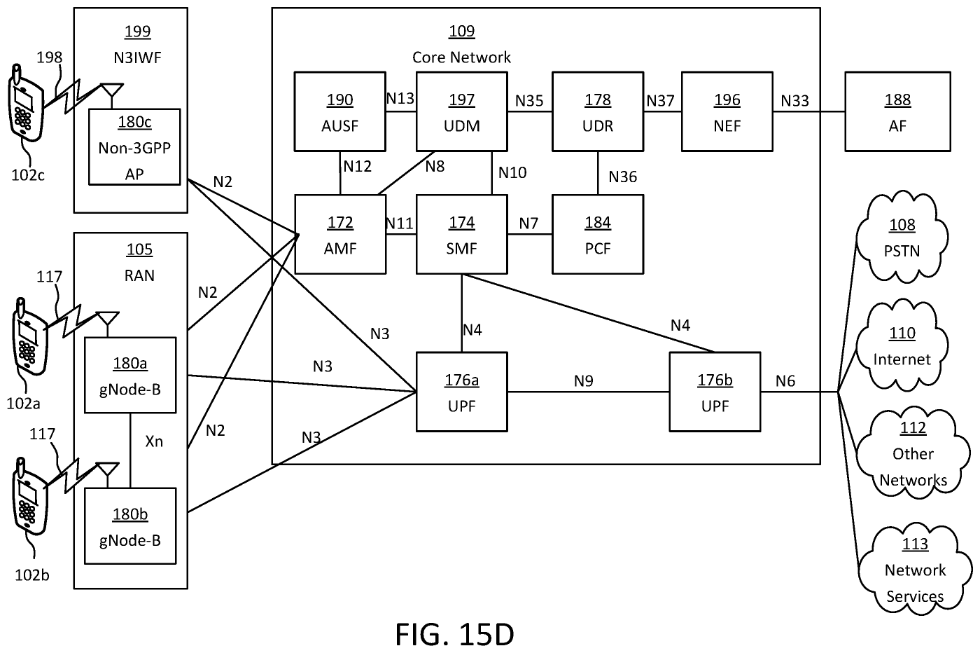

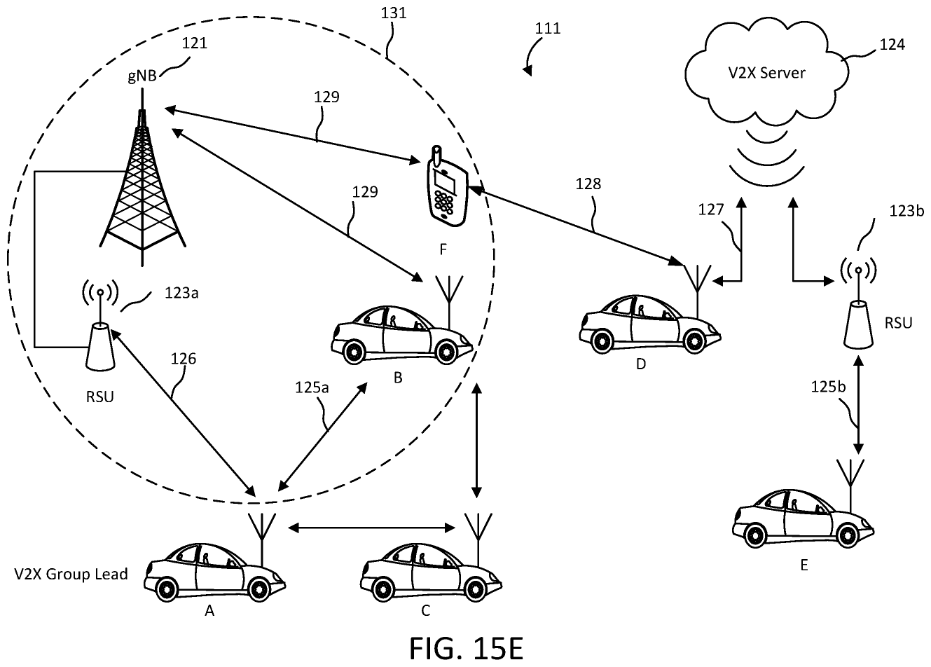

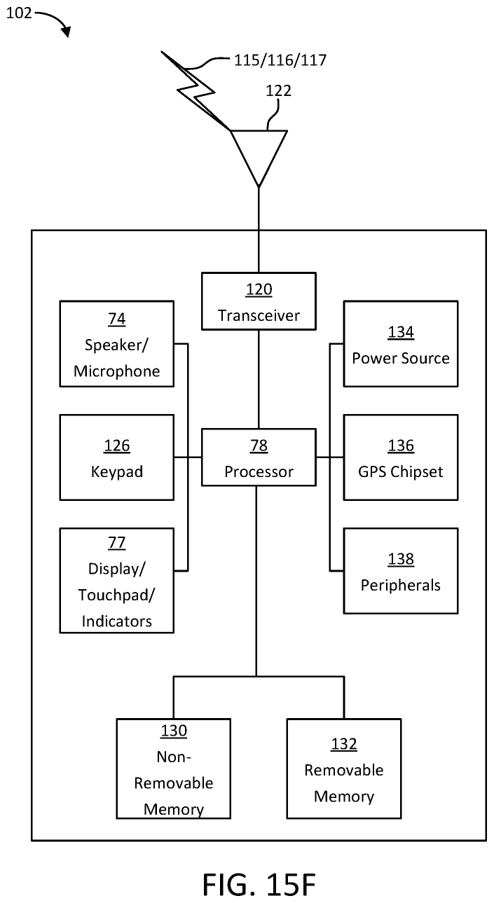

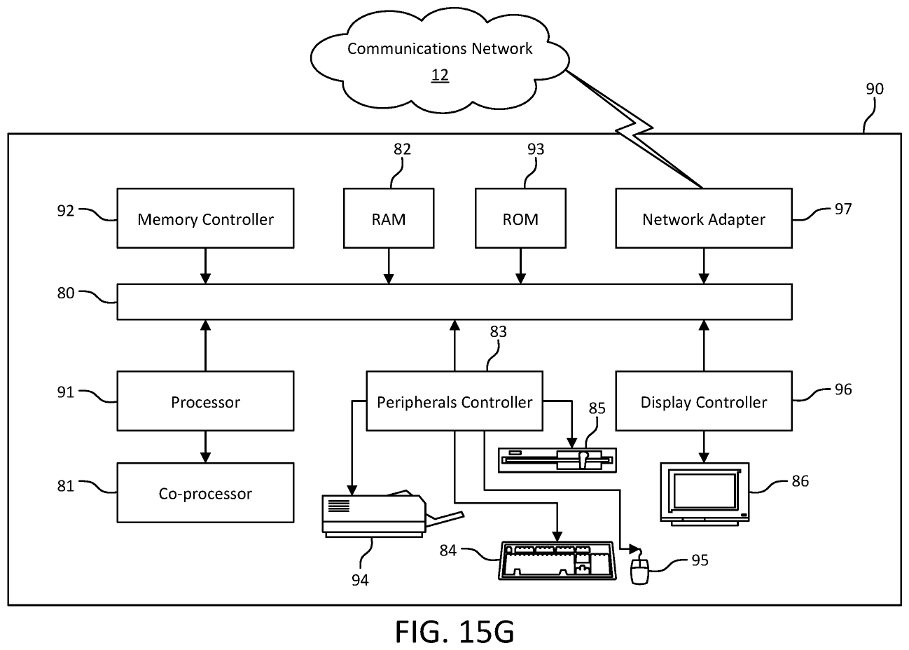

It is understood that the entities performing the steps illustrated herein may be logical entities. The steps may be stored in a memory of, and executing on a processor of, a device, server, or computer system such as those illustrated in FIG. 15F or FIG. 15G. Skipping steps, combining steps, or adding steps between exemplary methods disclosed herein (e.g., FIG. 13-FIG. 14) is contemplated.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 15A illustrates an example communications system 100 in which the methods and apparatuses of dynamic user plane management, such as the systems and methods illustrated in FIG. 11 through FIG. 14 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 15A, FIG. 15B, FIG. 15C, FIG. 15D, FIG. 15E, or FIG. 15F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 15A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of dynamic user plane management, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 15A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of dynamic user plane management, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 15A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 15A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of dynamic user plane management, as disclosed herein. For example, the WTRU 102g shown in FIG. 15A may be configured to communicate with the base station 114a, which may employ a cellular-based radio technology, and with the base station 114c, which may employ an IEEE 802 radio technology.

Although not shown in FIG. 15A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 15B is a system diagram of an example RAN 103 and core network 106 that may implement methods, systems, and devices of dynamic user plane management, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 15B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 15B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 15B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 15C is a system diagram of an example RAN 104 and core network 107 that may implement methods, systems, and devices of dynamic user plane management, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 15C, the eNode-Bs 160a, 160b, and 160c may communicate with one another over an X2 interface.

The core network 107 shown in FIG. 15C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 15D is a system diagram of an example RAN 105 and core network 109 that may implement methods, systems, and devices of dynamic user plane management, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 15D, the gNode-Bs 180a and 180b may communicate with one another over an Xn interface, for example.

The core network 109 shown in FIG. 15D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 15G.

In the example of FIG. 15D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 15D shows that network functions directly connect with one another, however, it should be appreciated that they may communicate via routing agents such as a diameter routing agent or message buses.

In the example of FIG. 15D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 15D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 15D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 15D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 15A, FIG. 15C, FIG. 15D, or FIG. 15E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 15A, FIG. 15B, FIG. 15C, FIG. 15D, or FIG. 15E are provided by way of example only, and it is understood that the subject matter disclosed and claimed herein may be embodied or implemented in any similar communication system, whether presently defined or defined in the future.

FIG. 15E illustrates an example communications system 111 in which the systems, methods, apparatuses that implement dynamic user plane management, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 15E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 15E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 15F is a block diagram of an example apparatus or device WTRU 102 that may be configured for wireless communications and operations in accordance with the systems, methods, and apparatuses that implement dynamic user plane management, described herein, such as a WTRU 102 of FIG. 15A, FIG. 15B, FIG. 15C, FIG. 15D, or FIG. 15E, or FIG. 11-FIG. 14 (e.g., remote UE 201, relay UE 202, or gNB 203). As shown in FIG. 15F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 15F and may be an exemplary implementation that performs the disclosed systems and methods for dynamic user plane management described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 15F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 15A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, LIDAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 15F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup in some of the examples described herein are successful or unsuccessful, or otherwise indicate a status of dynamic user plane management including associated components. The control lighting patterns, images, or colors on the display or indicators 77 may be reflective of the status of any of the method flows or components in the FIG.'s illustrated or discussed herein (e.g., FIG. 11-FIG. 14, etc.). Disclosed herein are messages and procedures of dynamic user plane management. The messages and procedures may be extended to provide interface/API for users to request resources via an input source (e.g., speaker/microphone 74, keypad 126, or display/touchpad/indicators 77) and request, configure, or query dynamic user plane management related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 15G is a block diagram of an exemplary computing system 90 in which one or more apparatuses of the communications networks illustrated in FIG. 15A, FIG. 15C, FIG. 15D and FIG. 15E as well as dynamic user plane management, such as the systems and methods illustrated in FIG. 11 through FIG. 14 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for dynamic user plane management, such as receiving message over the control plane or user plane.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 15A, FIG. 15B, FIG. 15C, FIG. 15D, or FIG. 15E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—dynamic user plane management—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for dynamic user plane management. A method, system, computer readable storage medium, or apparatus provides for receiving a request to manage a data traffic flow from or to a second device with QoS requirements; obtaining path selection context information from the second device; obtaining path selection context information from a third device; selecting one or more paths to establish user plane connections for the traffic flow based on obtained path selection context information and QoS requirement of the traffic flow; configuring the second device and the third device to establish User Plane connection; and mapping data flow traffic to one or more UP connections. The first device may include a base station (e.g., eNB or gNB), the second device may include a remote UE, and the third device may include a relay UE. The first device may receive the request from a fourth device or the second device. The fourth device may include an AMF. The path selection context information obtained from the second device may include the power consumption requirement, channel busy ratio, a list of candidates of second device, or the preference of a second device. The path selection context information obtained from the third device includes the channel busy ratio, or battery status. The first device may select the third device to forward the data traffic flow to the second device to minimize the power consumption of the second device. The first device may select to forward the data traffic flow directly to the second device to meet the latency requirement of the data traffic flow. The first device may select the third device to forward the data traffic flow indirectly to or from the second device or simultaneously forward the data traffic flow directly to the second device to meet the reliability requirement of the data traffic flow. The first device may configure the third device to forward the data traffic to or from the second device based on the QoS of the data traffic flow. All combinations in this or subsequent paragraphs (including the removal or addition of steps) are contemplated in a manner that is consistent with the other portions of the detailed description.

The first device may configure the second device to transmit to the third device or receive from the third device for a specified data traffic flow based on the QoS of the data traffic flow. The second or third devices may establish a connection based on the configuration information received from the first device. The second or third devices release a connection based on the configuration information received from the first device. The first device configures the second device directly. The first device may reselect one or more paths to establish user plane connection for the traffic flow if the current user plane connection cannot meet the QoS requirement of the traffic flow. The UP connections may be a direct connection and one of more indirect connection via the third device. The first device maps the data flow packet to one or more PDCP entities. The first device maps the data flow packet to the same PDCP entities but one or more RLC entities. All combinations in this or subsequent paragraphs (including the removal or addition of steps) are contemplated in a manner that is consistent with the other portions of the detailed description.

A method, system, computer readable storage medium, or apparatus provides for receiving, by a first device, path selection context configuration information over a first path from a second device; based on the received ‘path selection context’ configuration information, sending path selection context information to the second device, over the first path; receiving ‘user plane connection’ configuration information over the first path, from the second device; based on the received ‘user plane connection’ configuration information, configuring the first device to communicate to the second device over a second path; and responding to the second device over the first path, accepting the received user plane connection configuration. The first path may be a direct path between the first device and the second device, and the second path may be an indirect path between the first device and the second device. The first path may be an indirect path between the first device and the second device, and the second path may be a direct path between the first device and the second device. The first device comprises a relay UE or a remote UE. The path selection context information may include battery status, load status, the power consumption requirement, channel busy ratio, a list of candidates preferred relay UEs, or number of attached remote UEs. The first device may be a remote UE or a relay UE. The user plane connection configuration information may include one or more of: bearer ID, UE ID of first device, UE ID of third device, remote UE ID, relay UE ID, radio link control (RLC) channel mapping configuration associated with a new sidelink connection, or quality of service (QoS) requirement of the traffic flow. The configuring the first device to communicate to the second device further may involve the first device establishing a sidelink connection to a third device. The first path may be over an indirect connection and the user plane connection configuration information may be carried in a PC5 Radio Resource Control (RRC) message from the third device. The path selection context information may be sent via a measurement report, a physical layer indication, a media access control (MAC) control element (CE), an RRC message, or a NAS message. The path selection context information may be sent based on request from the second device, periodically, or based on some triggered event. All combinations in this paragraph (including the removal or addition of steps) are contemplated in a manner that is consistent with the other portions of the detailed description.

1. A method comprising:
receiving, by a wireless transmit/receive unit (WTRU), configuration information for beam management from a base station,
wherein the configuration information comprises transmission configuration indication (TCI) state information and a bandwidth part (BWP) configuration,
wherein the TCI state information comprises one or more TCI states for a serving cell configuration or one or more TCI states for a neighbor cell configuration, and a circular polarization indication, and
wherein the one or more TCI states are associated with a time value;
updating, based on the time value, the one or more TCI states; and
managing one or more beams of the WTRU based on the one or more updated TCI states.

2. The method of claim 1, wherein the circular polarization indication comprises left-hand circular polarization (LHCP) or right-hand circular polarization (RHCP).

3. The method of claim 1, wherein the base station is a non-terrestrial device or the base station communicates with a non-terrestrial device.

4. The method of claim 1, further comprising receiving a group common medium access control-control element (MAC-CE) for the indication of a group of non-terrestrial WTRUs that include the WTRU.

5. The method of claim 4, wherein the group common medium access control control element (MAC-CE) refers to a MAC-CE multiplexed in multicast shared channel.

6. The method of claim 1, wherein the TCI state information comprises a TCI indication for physical downlink control channel (PDCCH) or physical downlink shared data channel (PDSCH) in a group common downlink control information (DCI) format.

7. The method of claim 1, further comprising updating a TCI state of the WTRU based on an indication of beam failure detection or a beam failure request.

8. The method of claim 1, further comprising, on condition that a frequency reuse factor (FRF) is greater than 1 or an indicated TCI state of the TCI state information is different than a current TCI state of the WTRU, performing BWP switching and TCI state update at the same time by WTRU.

9. A wireless transmit/receive unit (WTRU), the WTRU comprises:
a processor; and
memory coupled with the processor, the memory storing executable instructions that when executed by the processor cause the processor to effectuate operations comprising:
receiving configuration information for beam management from a base station,
wherein the configuration information comprises transmission configuration indication (TCI) state information and a bandwidth part (BWP) configuration,
wherein the TCI state information comprises one or more TCI states for a serving cell configuration or one or more TCI states for a neighbor cell configuration, and a circular polarization indication, and
wherein the one or more TCI states are associated with a time value;
updating, based on the time value, the one or more TCI states; and
managing one or more beams of the WTRU based on the one or more updated TCI states.

10. The WTRU of claim 9, wherein the circular polarization indication comprises left-hand circular polarization (LHCP) or right-hand circular polarization (RHCP).

11. The WTRU of claim 9, wherein the base station is a non-terrestrial device or the base station communicates with a non-terrestrial device.

12. The WTRU of claim 9, further comprising receiving a group common medium access control-control element (MAC-CE) for the indication of a group of non-terrestrial WTRUs that include the WTRU.

13. The WTRU of claim 12, wherein the group common medium access control control element (MAC-CE) refers to a MAC-CE multiplexed in multicast shared channel.

14. The WTRU of claim 9, wherein the TCI state information comprises a TCI indication for physical downlink control channel (PDCCH) or physical downlink shared data channel (PDSCH) in a group common downlink control information (DCI) format.

15. The WTRU of claim 9, further comprising updating a TCI state of the WTRU based on an indication of beam failure detection or a beam failure request.

16. A computer readable storage medium storing computer executable instructions that when executed by a computing device cause the computing device to effectuate operations comprising:
receiving, by a wireless transmit/receive unit (WTRU), configuration information for beam management from a base station,
wherein the configuration information comprises transmission configuration indication (TCI) state information and a bandwidth part (BWP) configuration,
wherein the TCI state information comprises one or more TCI states for a serving cell configuration or one or more TCI states for a neighbor cell configuration, and a circular polarization indication, and
wherein the one or more TCI states are associated with a time value;
updating, based on the time value, the one or more TCI states; and
managing one or more beams of the WTRU based on the one or more updated TCI states.

17. The computer readable storage medium of claim 16, wherein the circular polarization indication comprises left-hand circular polarization (LHCP) or right-hand circular polarization (RHCP).

18. The computer readable storage medium of claim 16, wherein the base station is a non-terrestrial device or the base station communicates with a non-terrestrial device.

19. The computer readable storage medium of claim 16, further comprising receiving a group common medium access control-control element (MAC-CE) for the indication of a group of non-terrestrial WTRUs that include the WTRU.

20. The computer readable storage medium of claim 16, further comprising updating a TCI state of the WTRU based on an indication of beam failure detection or a beam failure request.
